(19) United States
(12) Patent Application Publication
(10) Pub. No.: US 2007/0126871 A1
(43) Pub. Date: Jun. 7, 2007

(54) Modular surveillance camera system with self-identification capability

(76) Inventors: Paul E. Henninger III, Lititz, PA (US); Michael D. Bolotine, Denver, CO (US)

Correspondence Address: BAKER & DANIELS LLP, 300 NORTH MERIDIAN STREET, SUITE 2700, INDIANAPOLIS, IN, 46204, US

(21) Appl. No.: 11/295,090

(22) Filed: Dec. 6, 2005

(51) Int. Cl. H04N 7/18

(52) U.S. Cl. 348/151

(57) ABSTRACT

A modular surveillance camera kit includes a group of camera heads each having a respective set of performance characteristics, a group of system controllers each having a respective set of performance characteristics, and a group of communications modules each having a respective set of performance characteristics. Each of the communications modules is configured to be coupled to a system interface. A surveillance camera system may be assembled in a selected one of a plurality of possible combinations by selecting one of the group of camera heads, one of the group of system controllers and one of the group of communications modules such that the selected system controller electrically and mechanically interconnects the selected camera head and the selected communications module. Each system controller is configured to ascertain an identification of the selected camera head and/or the selected communications module that is assembled in a same surveillance camera system as the system controller. Each system controller is also configured to operate the surveillance camera system dependent upon the identification.

### BACKGROUND OF THE INVENTION

1. Field of the Invention

The present invention relates to surveillance camera systems, and, more particularly, to surveillance camera systems that are subject to being occasionally serviced or upgraded.

2. Description of the Related Art

Surveillance camera systems are commonly used by retail stores, banks, casinos and other organizations to monitor activities within a given area. Typical surveillance camera systems are constructed as a single unit. When any portion of the camera system is faulty, the entire unit must be removed from a mounted arrangement and returned to the manufacturer. The manufacturer tests the faulty system to determine the source of the problem, but this process sometimes yields no information about what is the source of the fault. Additionally, the manufacturer is provided with little or no knowledge about the operation of the system as installed because the system is not capable of producing and storing (i.e., “logging”) such information. Such a configuration hampers the ability of field repairs of existing units and causes a number of warranty return problems because the manufacturer has no information about the problems that occurred while the system was in operation.

The unitary construction of the typical surveillance camera system prevents easy reconfiguration, upgrading, and maintenance of existing units. When individual components in the system need to be upgraded or replaced, the entire unit must be removed and replaced with a new unit. This requirement of replacing the entire system whenever an individual component thereof needs to be replaced or upgraded adds to the cost and complexity of maintaining, upgrading and/or reconfiguring the camera system.

What is needed in the art is a surveillance camera system that does not need to be replaced as a unit whenever an individual component of the system needs to be replaced or upgraded. What is also needed is the capability to identify versions of the individual modules within the system for data gathering and diagnostic purposes and for use in deciding how the system should be operated.

### SUMMARY OF THE INVENTION

The present invention provides a modular surveillance camera system that can be quickly and easily serviced in the field when individual components need to be replaced or updated. The modular camera system generally includes a camera housing module, a communications module, a system control module, and a camera head module. The system optionally includes a thermal management module. The camera housing is attached to an external mounting structure which connects the camera system to a wall or ceiling of a building. Each of the communications module, the system control module, the camera head module, and the thermal management module may be selectively replaced with a similar or upgraded version of the module quickly and easily, and without interfering with the remainder of the camera system. The system control module is capable of identifying the version of each of the modules in the system, including its own version, and operating the system based upon the identified versions. The identification data may also be combined with data collected from the modules for diagnostic purposes.

The invention also enables the modules to be replaced while electrical power remains applied to the system. Thus, the system may be energized throughout the replacement process. Various modules may include in-rush current limiting devices that protect the modules from transient current spikes.

The invention comprises, in one form thereof, a modular surveillance camera kit including a group of camera heads each having a respective set of performance characteristics, a group of system controllers each having a respective set of performance characteristics, and a group of communications modules each having a respective set of performance characteristics. Each of the communications modules is configured to be coupled to a system interface. A surveillance camera system may be assembled in a selected one of a plurality of possible combinations by selecting one of the group of camera heads, one of the group of system controllers and one of the group of communications modules such that the selected system controller electrically and mechanically interconnects the selected camera head and the selected communications module. Each system controller is configured to ascertain an identification of the selected camera head and/or the selected communications module that is assembled in a same surveillance camera system as the system controller. Each system controller is also configured to operate the surveillance camera system dependent upon the identification.

The invention comprises, in another form thereof, a modular surveillance camera kit including a group of camera heads each having a respective set of performance characteristics, a group of system controllers each having a respective set of performance characteristics, and a group of communications modules each having a respective set of performance characteristics. Each of the communications modules is configured to be coupled to a system interface. A surveillance camera system may be assembled in a selected one of a plurality of possible combinations by selecting one of the group of camera heads, one of the group of system controllers, and one of the group of communications modules such that the selected system controller electrically and mechanically interconnects the selected camera head and the selected communications module. Each system controller is configured to ascertain identifications of the selected camera head and of the selected communications module that are assembled in a same surveillance camera system as the system controller. Each system controller is also configured to determine, based upon the identifications, whether the selected camera head, the selected communications module, and the system controller that are assembled in the same surveillance camera system are operationally compatible with one another. Each system controller is further configured to notify a user if the selected camera head, the selected communications module, and the system controller that are assembled in the same surveillance camera system are not operationally compatible with one another.

The invention comprises, in yet another form thereof, a surveillance camera system including a camera head module, a communications module coupled to a system interface, a thermal module, and a system controller module in communication with each of the camera head module, the communications module, and the thermal module. The system controller is configured to ascertain identifications of the camera head module, of the communications module, and of the thermal module. Each of the identifications corresponds to a respective set of performance characteristic. The system controller is also configured to collect diagnostic data and/or environmental data associated with operation of the camera head module, the communications module, the thermal module, and/or the system controller module. The system controller is further configured to determine whether the camera head module, the communications module, the thermal module, and/or the system controller module should be replaced with a like module. The determination is based upon the identifications and upon the diagnostic data and/or environmental data. The system controller is still further configured to notify a user if the camera head module, the communications module, the thermal module, and/or the system controller module should be replaced.

The invention comprises, in a further form thereof, a modular surveillance camera kit including a group of camera heads each having a respective set of performance characteristics, a group of system controllers each having a respective set of performance characteristics, a group of communications modules each having a respective set of performance characteristics and each being configured to be coupled to a system interface, and a group of thermal modules each having a respective set of performance characteristics. A surveillance camera system may be assembled in a selected one of a plurality of possible combinations by selecting one of the group of camera heads, one of the group of system controllers, one of the group of communications modules, and one of the group of thermal modules such that the selected system controller electrically and mechanically interconnects the selected camera head and the selected communications module, and the selected thermal module is in communication with the system controller. Each system controller is configured to ascertain identifications of the selected camera head, of the selected communications module, and of the selected thermal module that are assembled in a same surveillance camera system as the system controller. Each system controller is also configured to collect diagnostic data and/or environmental data associated with operation of the assembled surveillance camera system. Each system controller is further configured to determine whether the selected camera head, the selected communications module, the selected thermal module, and/or the system controller that are assembled in the same surveillance camera system should be replaced with an other of a same group. The determination is based upon the identifications and upon the diagnostic data and/or environmental data. Each system controller is still further configured to notify a user if the selected camera head, the selected communications module, the selected thermal module, and/or the system controller that are assembled in the same surveillance camera system should be replaced.

The invention may be used in conjunction with either a PTZ camera or a fixed camera. In the case of a PTZ camera, an integral motor driver printed circuit board may power the pan, tilt and lens motors in the PTZ camera head. In the case of a fixed camera head gimbal, a crown plate assembly may be used to imitate the same configuration as the PTZ connect/disconnect mechanism and electrical connector. Hot swap circuitry may be provided to protect electronics on either side of the interface.

An advantage of the present invention is that individual modules that are included in the camera system may be quickly and easily removed and replaced with a fully functioning or upgraded module without removing the camera system from its use in the field, and the identification and associated performance characteristics of the replacement module may be quickly and easily determined by the system.

Another advantage is that diagnostic, environmental and performance data may be recorded in association with the identifications of the modules included in the system.

Yet another advantage is that the particular system configuration, including the identifications of the individual modules, may be retrieved remotely, such as by a head end unit.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective, partially exploded view of one embodiment of a surveillance camera assembly suitable for use in a surveillance camera system of the present invention;

FIG. 2 is an exploded view of the mounting frame, camera head base and pan plate of the surveillance camera assembly of FIG. 1;

FIG. 3 is a perspective, overhead view of the camera head base of FIG. 2 without the crown plate;

FIG. 4 is a perspective, overhead view of the camera head base of FIG. 2 with the crown plate;

FIG. 5 is a perspective, bottom view of the locking device of the camera head base of FIG. 2;

FIG. 6 is a flow chart of one embodiment of a method for arranging a surveillance camera assembly;

FIG. 7 is a perspective view of the surveillance camera assembly of FIG. 1 after a first step of installation;

FIG. 8 is a perspective view of the surveillance camera assembly of FIG. 1 after a second step of installation;

FIG. 9 is an exploded perspective view of one embodiment of a modular surveillance camera system of the present invention, including the surveillance camera assembly of FIG. 1;

FIG. 10 is a schematic view of interconnections between modules of the modular surveillance camera system of FIG. 9;

FIG. 11 is a block diagram of the modular surveillance camera system of FIG. 9;

FIG. 12 is another block diagram of the modular surveillance camera system of FIG. 9, further illustrating the system controller module and the camera head module;

FIG. 13 is yet another block diagram of the modular surveillance camera system of FIG. 1, further illustrating the communications module, the thermal module, the power supply sub-module, and the interface board;

FIG. 14 is a block diagram of another embodiment of a modular surveillance camera system of the present invention;

FIG. 15 is a bottom plan view of the housing module of the modular surveillance camera system of FIG. 9;

FIG. 16 is a bottom plan view of the printed circuit board support assembly of the housing module of FIG. 15;

FIG. 17 is a perspective view of the printed circuit board support assembly of the housing module of FIG. 15;

FIG. 18 is a bottom perspective view of the communications module of the modular surveillance camera system of FIG. 9 positioned to be inserted into the printed circuit board support assembly of FIG. 17;

FIG. 19 is a bottom perspective view of the thermal module of the modular surveillance camera system of FIG. 9 positioned to be inserted into the printed circuit board support assembly of FIG. 17;

FIG. 20 is a bottom perspective view of the communications module and thermal module of the modular surveillance camera system of FIG. 9 positioned to be inserted into the printed circuit board support assembly of FIG. 17;

FIG. 21 is a bottom perspective view of the communications module and thermal module of the modular surveillance camera system of FIG. 9 inserted in the printed circuit board support assembly of FIG. 17;

FIG. 22 is a top perspective view of the system control module and fragmentary views of the communications module and thermal module of the modular surveillance camera system of FIG. 9; and

FIG. 23 is a bottom plan view of the communications module, the thermal module, and the system control module inserted into the housing module of the modular surveillance camera system of FIG. 9.

Corresponding reference characters indicate corresponding parts throughout the several views. Although the exemplifications set out herein illustrate the invention, in one form, the embodiments disclosed below are not intended to be exhaustive or to be construed as limiting the scope of the invention to the precise form disclosed.

### DESCRIPTION OF THE PRESENT INVENTION

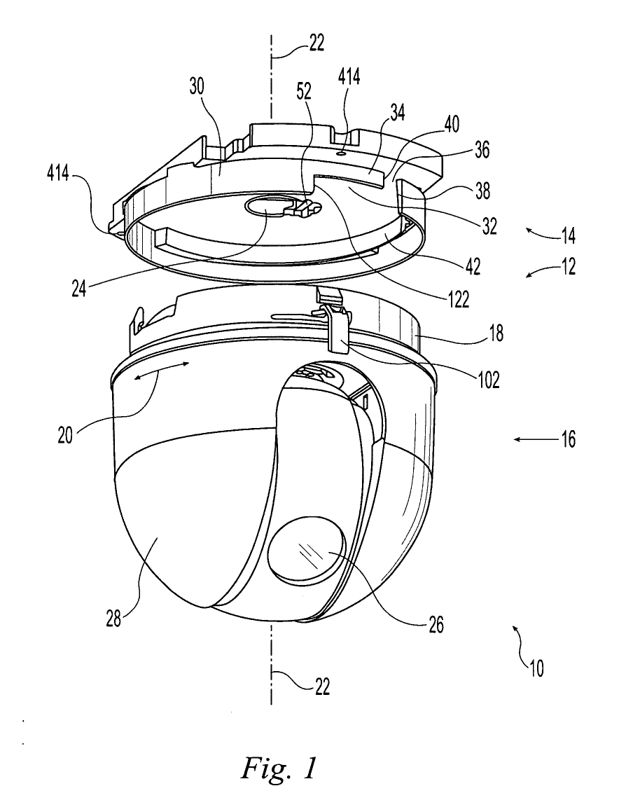

Referring now to the drawings, and particularly to FIG. 1, there is shown one embodiment of a surveillance camera assembly 10 that may be included in the modular surveillance camera system of the present invention, including a camera head assembly module 12 and a mounting apparatus in the form of a mounting frame 14. Camera head assembly module 12 includes a camera head 16 coupled to a camera head base 18. More particularly, camera head 16 may be rotatingly attached to camera head base 18 via a circumferential ball bearing (not shown). An inner race of the bearing which is attached to head 16 may be hooked onto an outer race of the bearing which is attached to base 18. Camera head assembly module 12 may be fixedly attached to mounting frame 14 such that camera head 16 is rotatable relative to camera head base 18 in directions indicated by double arrow 20 about a pan axis or longitudinal axis 22, while camera head base 18 remains fixed to mounting frame 14.

Mounting frame 14 may include a through channel 24 for carrying wires (not shown) therein. The wires may provide electrical power and control signals from a camera monitoring system or “head end unit” to a surveillance camera 26 within a covert liner 28 of camera head 16. The wires may also carry signals, including video signals, from camera 26 to the camera monitoring system, which may include a video display unit.

Mounting frame 14 also includes a circumferential wall 30 having a notch 32 exposing a ridge 34. A slot 36 is defined between an end 38 of wall 30 and a distal end 40 of ridge 34. Mounting frame 14 further includes two mating catches 42, only one of which is visible in FIG. 1.

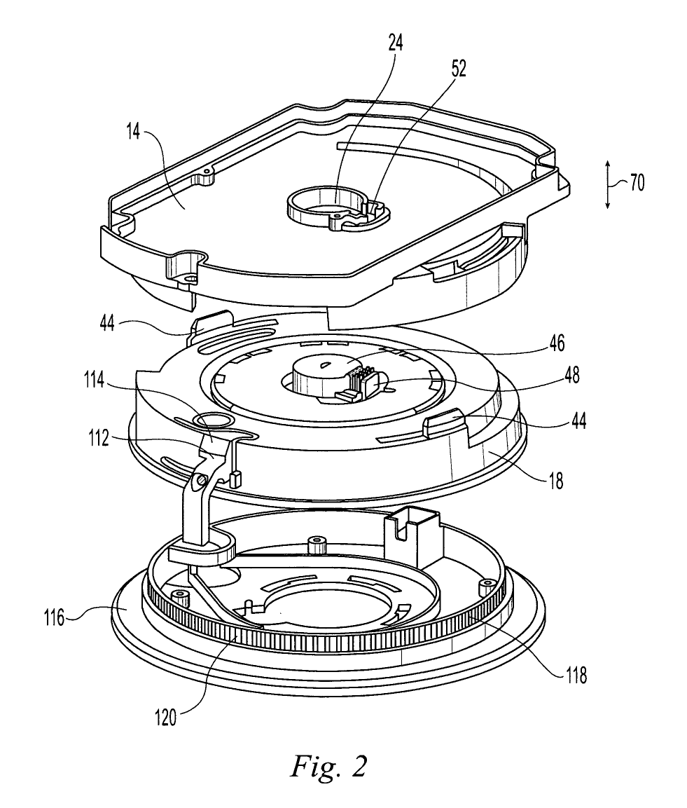

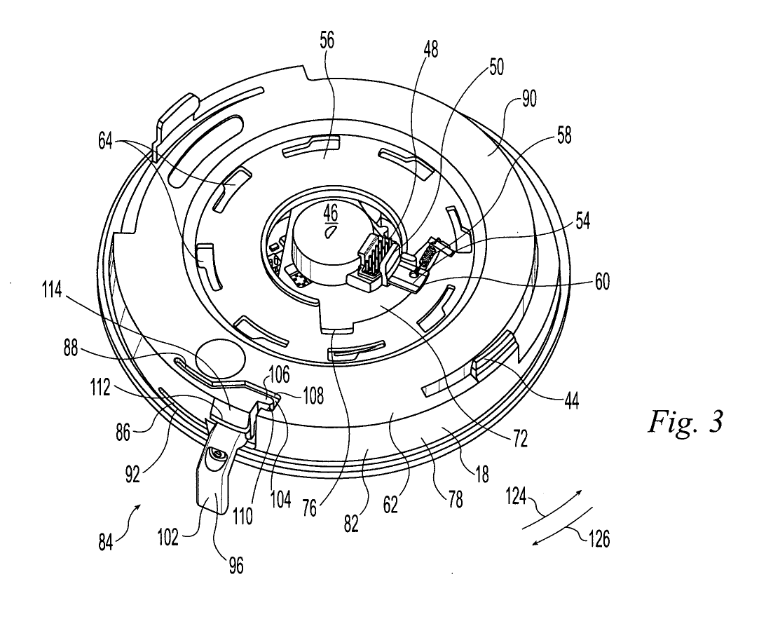

Camera head base 18 includes two bayonet catches 44 (FIG. 2) for matingly latching with catches 42 to thereby secure camera head assembly module 12 to mounting frame 14, as discussed in more detail below. Base 18 also includes a slip ring connector, only a cap 46 of which is shown in the drawings. Cap 46 is tapered, thus facilitating cap 46 being received in through channel 24 of mounting frame 14. The slip ring connector enables camera head 16 to rotate freely while still maintaining electrical contact between camera 26 and the wires carried in through channel 24. More particularly, the slip ring has a bottom terminal that is rotatable along with camera head 16, and a fixed upper terminal that is attached to cap 46 and to a twelve pin connector 48 that is best shown in FIG. 3. Connector 48 is matingly connectable to another blind connector that may be housed in frame 14 and attached to the wires carried in through channel 24. Frame 14 may locate this connector in a connector pocket. The mounting holes on the printed circuit board on which this blind connector is soldered may be oversized to ensure that the frame's primary registration is to the connector. Bayonet catches 44 may extend beyond connector 48 in an axial direction to thereby protect connector 48 when camera head 16 is being handled before installation.

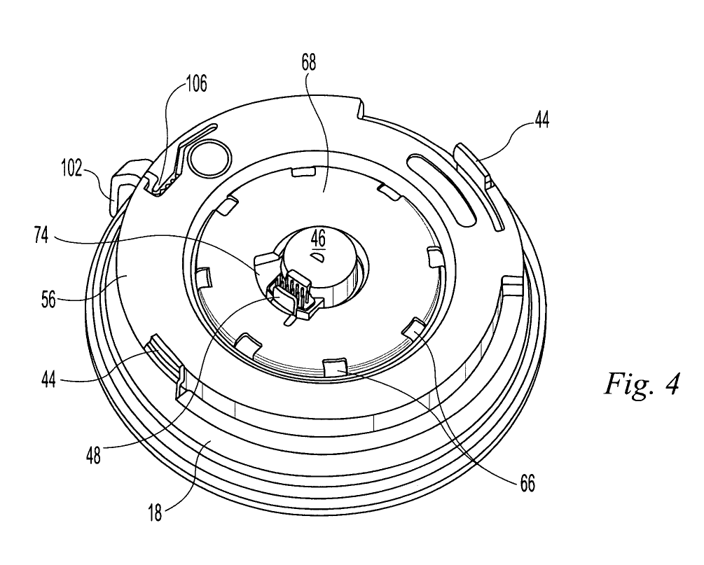

Connector 48 includes an axial tab 50 that may be received in a recess 52 of channel 24 in mounting frame 14. Recess 52 may be precisely located relative to the connector pocket and may thus ensure proper rotational position of the blind connector received in the connector pocket. Connector 48 also includes a radial tab 54. Tab 54 is connected to a body 56 of camera head base 18 by a spring 58. Further, an end 60 of tab 54 is supported by an upper surface 62 of body 56. Body 56 includes slots 64 for receiving projections 66 (FIG. 4) of a crown plate 68 to thereby secure crown plate 68 to body 56. When crown plate 68 is secured to body 56, radial tab 54 is sandwiched between body 56 and crown plate 68. Thus, radial tab 54 is prevented from moving in axial directions 70 (FIG. 2) parallel to pan axis 22 when connector 48 is connected and disconnected from the connector attached to the wires carried within through channel 24. That is, the sandwiching of radial tab 54 between body 56 and crown plate 68 may prevent potentially damaging torque from being exerted on connector 48 during the connection and disconnection of connector 48 from the other corresponding connector.

In one embodiment, a radially inward section of upper surface 62, generally bounded by slots 64, is recessed in an axial direction 70 below a radially outward section of upper surface 62. This recessed portion of upper surface 62 may receive crown plate 68. Thus, after assembly, an upper surface of crown plate 68 may be substantially coplanar with the radially outward section of upper surface 62.

As shown in FIGS. 3 and 4, body 56 and crown plate 68 have respective arcuate cut-outs 72, 74 for receiving connector 48 and allowing body 56 and crown plate 68 to rotate relative to connector 48 and cap 46, as discussed in more detail below. Body 56 also includes a radial slot 76 that is an extension of cut-out 72. During assembly, radial tab 54 may be passed through slot 76 before tab 54 is connected to spring 58.

Advantageously, connector 48 is disposed radially adjacent to slip ring cap 46, i.e., is disposed at approximately the same point along pan axis 22 as cap 46. In contrast, known connectors are displaced in the axial direction from the slip ring, thereby adding to the overall length of the camera assembly in the axial direction.

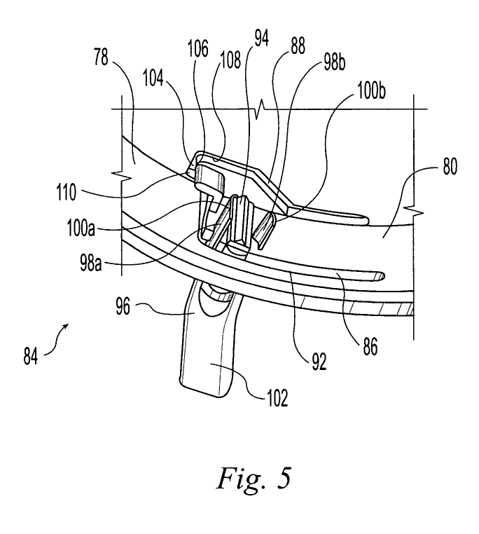

Body 56 includes a circumferential wall 78 having an inner surface 80 (FIG. 5) and an outer surface 82. Camera head base 18 includes a locking device 84 that may be spring-biased by virtue of a substantially U-shaped throughslot 86 having a first leg 88 in a radially oriented portion 90 of body 56, and a second leg 92 in circumferential wall 78. Locking device 84 includes a rotational locking element in the form of a tooth or rib 94 on inner surface 80. Rib 94 may be oriented parallel to axial directions 70.

Extending through circumferential wall 78 is a manual actuator 96 that may be formed of metal for superior strength and durability. Actuator 96 may be insert molded into wall 78, which may be formed of plastic. Manual actuator 96 may have locking elements 98a, 98b extending through wall 78 in a radially inward direction. Locking elements 98a, 98b may have respective ribs 100a, 100b that may extend farther than the remainder of elements 98a, 98b in the radially inward direction. Ribs 100a, 100b may extend in a radially inward direction approximately as far as rib 94 does. Manual actuator 96 includes a handle 102 disposed radially outward of wall 78.

Throughslot 86 includes a smaller U-shaped section 104 within the overall U-shape of throughslot 86. Locking device 84 includes a limit tab 106 defined by section 104 of throughslot 86. The freedom of movement of locking device 84 in the radially inward and radially outward directions may be limited to the width of throughslot 86 in U-shaped section 104. More particularly, the movement of locking device 84 in the radially inward direction may be limited by limit tab 106 engaging a radially inward side 108 of section 104. Similarly, the movement of locking device 84 in the radially outward direction may be limited by limit tab 106 engaging a radially outward side 110 of section 104. Axially displaced from handle 102 is a radially outwardly projecting cam 112 having a tapered surface 114 for engaging ridge 34.

In addition to surveillance camera 26 and covert liner 28, camera head 16 may include a pan plate 116 to which camera 26 and covert liner 28 may be fixedly attached. Pan plate 116 includes slots 118 via which pan plate 116 may be attached to one race of the pan axis ball bearing (not shown). Thus, pan plate 116 may be rotatable relative to camera head base 18. Pan plate 116 includes a circumferential wall 118 having ribs 120 extending parallel to axial directions 70. Ribs 120 may be distributed 360° around wall 118.

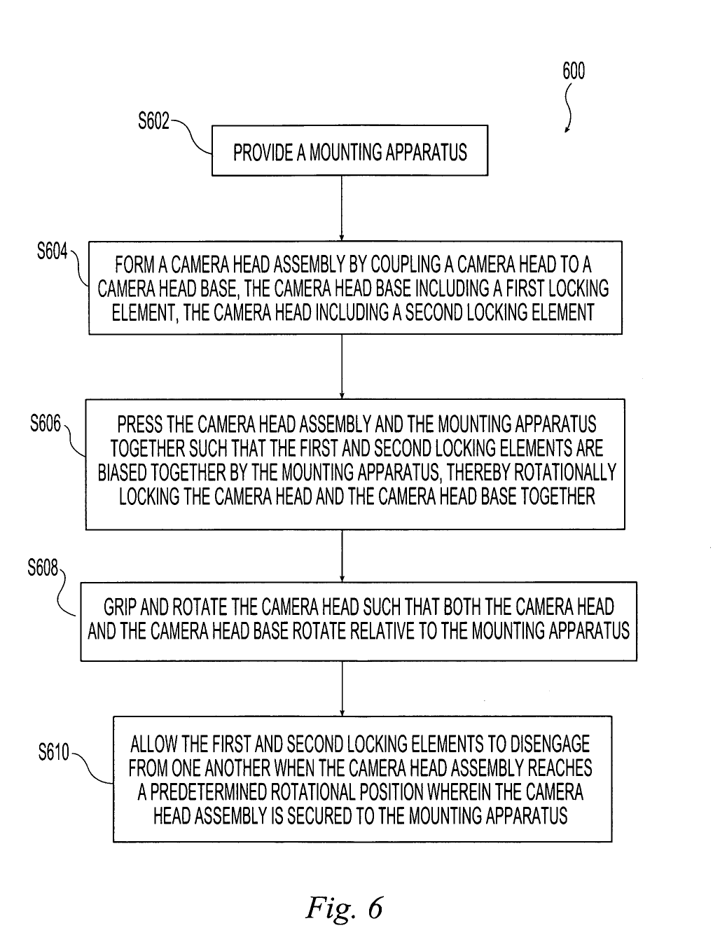

In general, camera head assembly module 12 may be secured to mounting apparatus 14 by moving camera head assembly module 12 toward mounting apparatus 14 in an axial direction 70 along pan axis 22, and rotating camera head assembly module 12 about axis 22. FIG. 6 illustrates one specific embodiment of a method 600 of the present invention for arranging a surveillance camera assembly. In a first step S602, a mounting apparatus such as mounting frame 14 is provided. In a second step S604, a camera head assembly is formed by coupling a camera head to a camera head base, the camera head base including a first locking element, the camera head including a second locking element. For example, camera head assembly module 12 may be assembled by inserting camera head 16 into camera head base 18. Circumferential wall 78 of base 18 may have an inner diameter that is slightly larger than the outer diameter of circumferential wall 118 of pan plate 116 such that first locking element ribs 94, 100a, 100b of base 18 face second locking element ribs 120 of pan plate 116, but do not mesh therewith. Since ribs 120 extend 360° around pan plate 116, camera head 16 may be in any rotational position relative to directions 20 (FIG. 1) when placed into engagement with camera head base 18.

In a third step S606, the camera head assembly and the mounting apparatus are pressed together such that the first and second locking elements are biased together by the mounting apparatus, thereby rotationally locking the camera head and the camera head base together. For example, camera head assembly module 12 may be moved toward mounting apparatus 14 in an axial direction 70 such that handle 102 is aligned with the left-hand end of notch, i.e., such that handle 102 is closely adjacent to or is touching side 122 of circumferential wall 30. That is, camera head base 18 may engage mounting frame 14.

As handle 102 is inserted into the left-hand side of notch 32, ridge 34 engages tapered surface 114 of cam 112, tapered cap 46 is guided into channel 24, and bayonet catches 44 engage mounting frame 14. Bayonet catches 44 may lead connector 48 during axial insertion in order to provide accurate rotational orientation therefor. Moreover, axial tab 50 is aligned with recess 52 of mounting frame 14 such that tab 50 is received in recess 52 and male connector 48 is mated with a female connector that is attached to the wires carried in through channel 24. The relative positions of connector 48 and body 56 may be as shown in FIG. 3.

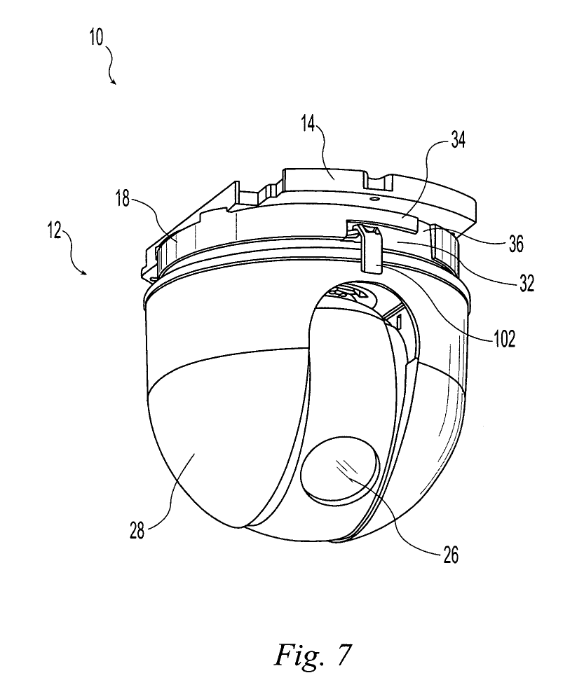

As assembly module 12 continues movement in the axial direction, cam 112 is pushed farther radially inward by ridge 34 until camera head assembly module 12 reaches a first position, as shown in FIG. 7. In addition to cam 112, the remainder of locking device 84, including ribs 94, 100a, 100b, is biased in the radially inward direction by ridge 34. Thus, ridge 34 functions to bias ribs 94, 100a, 100b against ribs 120 to thereby rotationally lock camera head 16 to camera head base 18. The meshing of ribs 94, 100a, 100b with ribs 120 may prevent either of camera head 16 and camera head base 18 from rotating about axis 22 without the other.

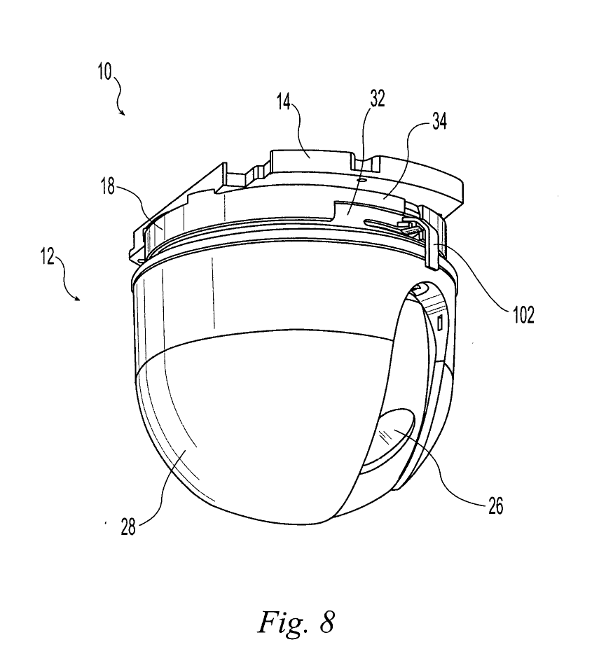

In a fourth step S608, the camera head may be gripped and rotated such that both the camera head and the camera head base rotate relative to the mounting apparatus. For example, covert liner 28 may be gripped by a human installer and rotated relative to the fixed mounting frame 14 such that camera head assembly module 12 is rotated from the first position shown in FIG. 7 to a second position shown in FIG. 8. Since camera head 16 and camera head base 18 are locked together by locking device 84, camera head base 18 rotates along with covert liner 28 and the rest of camera head 16. Thus, covert liner 28 can be used to transfer torque to camera head base 18.

As camera head assembly module 12 rotates relative to mounting frame 14, bayonet catches 44 on camera head base 18 engage and are coupled to mating catches 42 on mounting frame 14. Thus, camera head assembly module 12 becomes secured to mounting frame 14 with regard to axial directions 70 and rotational directions 20. Also occurring as camera head assembly module 12 rotates relative to mounting frame 14, camera head base 18 rotates in the direction indicated by arrow 124 in FIG. 3 while cap 46, connector 48, axial tab 50 and radial tab 54 remain fixed. Thus, slot 76 moves closer to radial tab 54, and spring 58, having one end attached to body 56 and another end attached to radial tab 54, becomes stretched. Slot 74 of crown plate 68 may be sized to limit rotation of slip ring cap 46 relative to base 18 to the angular bayonet engagement range.

In a fifth step S610, the first and second locking elements are allowed to disengage from one another when the camera head assembly reaches a predetermined rotational position wherein the camera head assembly is secured to the mounting apparatus. For example, when camera head assembly module 12 is in the second position shown in FIG. 8, cam 112 has moved entirely past ridge 34 and into slot 36 such that ridge 34 no longer biases cam 112 in a radially inward direction. That is, locking device 84 is no longer biased radially inward. Thus, when camera head assembly module 12 is in the second position, ribs 94, 100a, 100b may disengage from ribs 120, and camera head 16 may rotate freely relative to both camera head base 18 and mounting frame 14.

During removal, or uninstallation, the human may push handle 102 radially inward in order to manually bias ribs 94, 100a, 100b and ribs 120 together. While continuing to push inwardly on handle 102, the human may grip covert liner 28 and rotate camera head 16 in a direction 126 opposite to direction 124. Thus, both camera head 16 and camera head base 18 are rotated relative to mounting frame 14 in direction 126. As camera head assembly module 12 rotates in direction 126, bayonet catches 44 are decoupled from matching catches 42, thus also decoupling camera head assembly module 12 from mounting frame 14. Camera head assembly module 12 may then be removed from mounting frame 14, and another camera head assembly may be installed on mounting frame 14 if so desired. After removal, extension spring 58 returns connector 48 to the same consistent position to ensure repeatable blind connections.

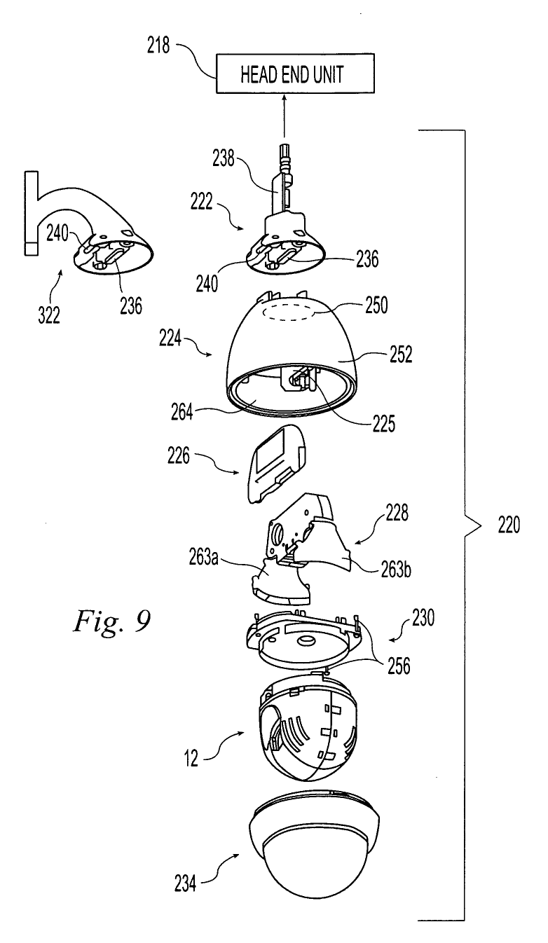

In FIG. 9, a modular surveillance camera system 220 of the present invention is shown as including, in addition to camera head assembly module 12 described above, a mounting module 222, a camera housing module 224, a communications module 226, a thermal module 228, a system control module 230, and a dome surveillance window 234. Via mounting module 222, system 220 may be in electrical communication with a camera monitoring device in the form of a head end unit 218. More particularly, mounting module 222 includes an exposed electrical connector 236 and a printed circuit board 238 connected to head end unit 218 via wiring (not shown).

Camera housing module 224 may be mechanically latched onto a mount hinge pin 240 of mounting module 222. Mounting module 222 is configured to be mounted to a ceiling of a room. However, system 220 may be included in a modular surveillance camera kit of the present invention, including a mounting module 322 that is configured to be mounted to a vertical surface such as a wall. Although the body of module 322 is configured to be mounted to a wall, modules 222, 322 have common electrical and mechanical connectors. More particularly, both modules 222 and 322 include electrical connector 236 and mount hinge pin 240. Thus, wall mounting module 322 is fully compatible with camera housing module 224 and the remainder of modular surveillance camera system 220. A pendant-type housing that is attached to a wall, and the coupling between a housing and a surveillance window, are disclosed in U.S. patent application Ser. No. 10/967,856, entitled COMPOUND DOME WINDOW FOR A SURVEILLANCE CAMERA, filed Oct. 18, 2004, which is hereby incorporated by reference herein.

According to the present invention, a modular surveillance camera kit may further include one or more additional versions of the communications module, the thermal module, the system control module, and the camera head assembly module. Thus, the kit may include a group of mounting modules, a group of communications modules, a group of thermal modules, a group of system control modules, and a group of camera head assembly modules. A user or assembler may select one module from each of the groups to thereby assemble a surveillance camera system in a selected one of a plurality of possible combinations. Each of the modules within a given group may have a respective set of performance characteristics and common electrical and mechanical connectors. Thus, each module may be interchangeable with a like module of the same group in terms of mechanical and electrical connectivity. However, it is possible within the scope of the invention that, due to the different performance characteristics of the modules within a group, not all modules within a given group are fully operationally compatible with all modules of the other groups.

When one of the modules needs to be upgraded or replaced due to a malfunction, the module may be relatively easily replaced with a like module without the need for special tools. Thus, the camera system may be upgraded or serviced in the field without having to send the entire camera system to a repair facility. Additionally, the camera system kit of the present invention advantageously allows a manufacturer to more easily manufacture replacement parts and new, more advanced parts due to the modular configuration. Thus, a user of the camera system can easily upgrade or reconfigure the system to the user's dynamic specifications.

Camera system 220, including one selected module from each of the groups, will be described in detail herein. However, it is to be understood that each of these modules is representative of the modules of their respective group in terms of electrical and mechanical connectivity, and perhaps also in terms of size and shape.

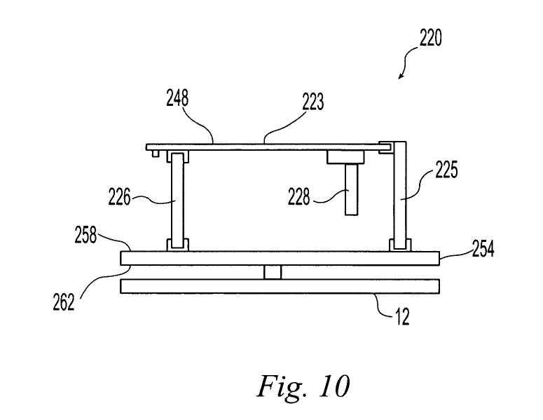

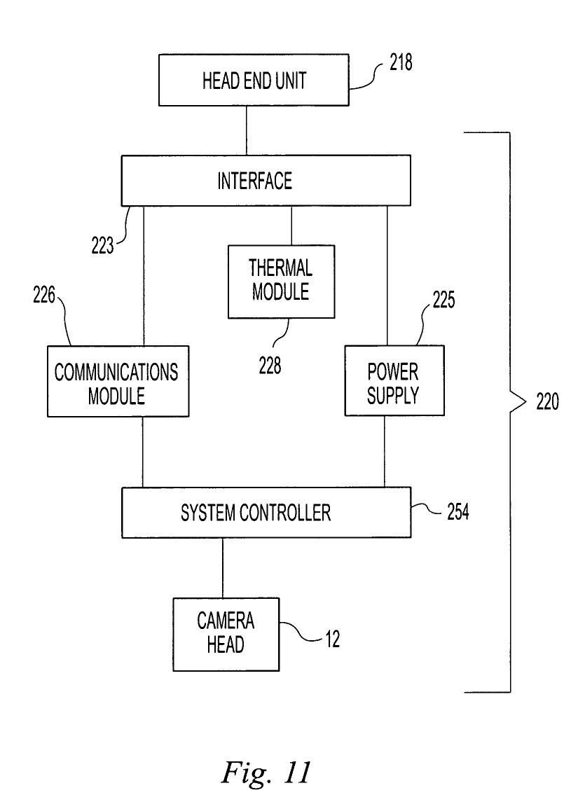

Camera housing module 224 may include a power supply sub-module 225 as well as a system interface board 223 which is shown in FIGS. 10 and 11. An upper surface 248 of interface board 223 may include pins or another type of electrical connector for mating with connector 236 of mounting module 222 through an upper opening 250 in a shell or housing 252. Opening 250 may be sealed to prevent ingress of water and dust. Interface board 223 and power supply sub-module 225 may be mechanically secured to housing 252 as well as electrically and mechanically connected to each other. Interface board 223 may be selectively electrically connected to communications module 226 and thermal management module 228, as described below.

Communications module 226 may include, for example, the Bosch Bilinx, Biphase, RS232, and RS485 circuitry or Ethernet and RS232 or passthrough circuitry. The inclusion of thermal management module 228 in the camera system is optional because various possible embodiments of the camera system may not require that the internal temperatures of the camera system be controlled. Because thermal module 228 is directly connected to interface board 223, thermal module 228 can be easily removed depending on the application.

System control module 230 may include a system controller 254 nested in an upper surface of mounting frame 14, which may be mechanically secured to housing 252 via screws 256. An upper surface 258 of system controller 254 may be electrically connected to communications module 226 and to power supply sub-module 225. Camera head module 12 is mechanically secured to mounting frame 14 as described above, and may be electrically connected to a lower surface 262 of system controller 254.

The interface between housing 252 and surveillance window 234 may be a snap-fit engagement, a bayonet-type engagement, a threaded engagement, or any other suitable connection, and may also contain a sealant to prevent dust, dirt, water, and other contaminants from entering camera system 220. When system 220 is fully assembled, communications module 226 and thermal management module 228, except for contoured ducts 263a-b, may be entirely disposed within housing 252. That is, communications module 226 and thermal management module 228, except for contoured ducts 263a-b, may be entirely disposed between upper opening 250 and a lower opening 264 of housing 252. System control module 230 and camera head module 12 may be at least partially disposed within housing 252. Housing 252 may be formed of an electrically conductive material so as to provide a shielding and thermal heat sinking effect for the electronic modules contained within it.

Contoured ducts 263a-b may distribute warm air downward on opposite sides of the camera head to keep the inner surface of enclosure window 234 free of fog or frost. The camera head may include an internal air return path that communicates with a bottom slotted intake area of thermal module 228.

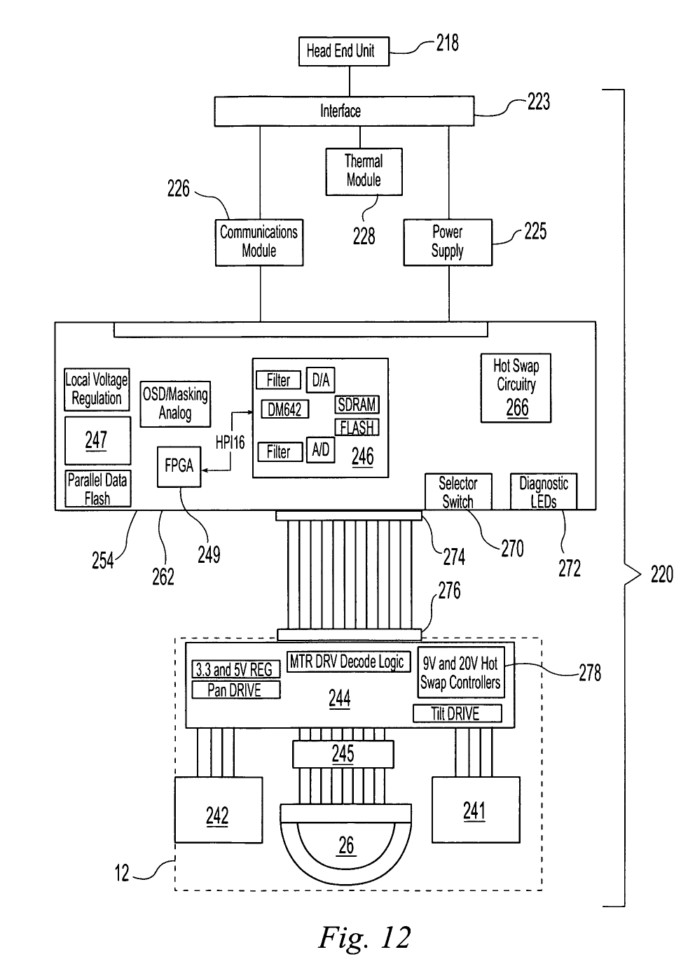

Referring now to FIG. 12, the components of system controller 254 and camera head module 12 are shown. System controller 254 may include electrical circuitry, e.g., hot swap circuitry 266 and/or tristatable signal lines, at the interface with communications module 226 and power supply sub-module 225, and/or at the interface with camera head module 12. Hot swap circuitry may include components to prevent an in-rush of current when a new module is installed with power supplied to the camera system. Alternatively, the electrical connections may comprise any other in-rush current limiting electrical connections. Such hot swap circuitry may include resistor-capacitor circuits or other dampening circuits for reducing the magnitude and/or time duration of voltage transients or current transients to which a module may be exposed upon being connected to an energized module. Hot swap circuitry essentially reduces the chance of damage from unintended current paths to components or modules that are added to the camera system while the power remains supplied thereto. For example, hot swap circuitry 266 may enable system controller 254 to be moved into electrical connection with an energized communications module 226 and/or with an energized power supply sub-module 225 with a reduced risk of damage therefrom. Hot swap circuitry 266 may additionally or alternatively enable camera head module 12 to be moved into electrical connection with an energized system controller 254 with a reduced risk of damage therefrom. Hot swap circuitry is described in an article entitled “Introduction to Hot Swap”, authored by Jonathan M. Bearfield of Texas Instruments, available at www.techonline.com, published on Sep. 24, 2001, the disclosure of which is hereby expressly incorporated herein by reference.

Tristatable signal lines may provide high, low, and disabled electrical states. The disabled state, in which the signal lines are provided with a high level of electrical resistance, may take effect whenever a video signal from the camera head is lost or is turned off. Thus, in the disabled state, a camera head may be serviced or replaced with a reduced risk of high currents entering and possibly damaging the camera head.

System controller 254 may include a video content analysis circuitry 246 in communication with field programmable gate array circuitry 249. System controller 254 may also include a microcontroller 247 in addition to the other components that are labeled in FIG. 12. A bottom surface 262 of system controller 254 may include a selector switch 270 and diagnostic light-emitting diodes 272 that may be actuated and observed, respectively, by a user of the system for diagnostic purposes, for example. System controller 254 may be connected to camera head module 12 via slip ring connectors 274, 276.

Camera head module 12 may include camera 26, tilt motor 241, pan motor 242, camera interface adapter 245, and slip ring/motor driver printed circuit board 244. Camera interface adapter 245 may enable interfacing with any of several brands of camera 26, including Sony, Bosch, Sanyo, Hitachi, Hercules or LG. PCB 244 may include hot swap circuitry in the form of nine volt and twenty volt hot swap controllers 278 which may protect PCB 244 from electrical spikes and transients when camera head module 12 is connected to an energized system controller 254. In addition the hot swap circuitry of 278 and 266 limit the current surge seen by power supply 225.

A particular mechanical coupling between camera head module 12 and mounting frame 14 of system control module 230 is described above with reference to FIGS. 1-8. However, it is to be understood that camera head module 12 may be coupled to mounting frame 14 via other suitable electrical and mechanical connections. For example, camera head module 12 may be mechanically attached to mounting frame 14 via a bayonet-type connection, a snap-fit engagement, a threaded engagement, one or more fasteners, or any other type of suitable connection which permits easy removal while simultaneously providing secure mechanical connection.

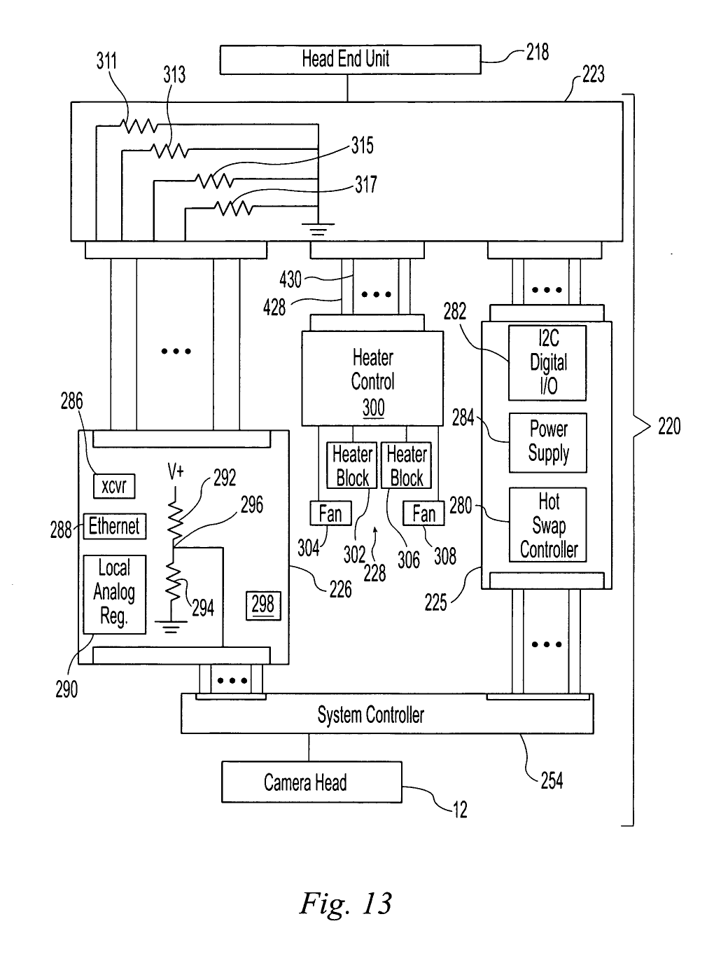

System controller 254 may be electrically connected to power supply sub-module 225 via a serial port connection therebetween, which is best shown in FIG. 13. Power supply sub-module 225 may include a printed circuit board having a hot swap controller 280, I2C digital I/O circuitry 282, and a power supply 284. Power supply 284 may convert an AC or DC voltage received from head end unit 218 into a DC voltage suitable for use by system controller 254, depending on the specific application.

Communications module 226 may include a transceiver 286, an Ethernet sub-module 288, and local analog regulation circuitry 290. Resistors 292, 294 form a voltage divider that produces a voltage level at node 296 that may be used by system controller 254 to identify the version of communications module 226. That is, the values of resistors 292, 294 may uniquely identify the version of communications module 226. Communications module 226 may also include hot swap circuitry 298 for protecting communications module 226 and/or system controller 254 in the event that communications module 226 is moved into connection with interface 223, or in the event that system controller 254 is moved into connection with communications module 226.

Thermal management module 228 may include a heater controller 300 in electrical communication with first heater block 302, associated fan 304, second heater block 306, and associated fan 308. Heater controller 300 may determine the internal temperature inside housing 252, determine whether heating or cooling needs to be supplied, and control heater blocks 302, 306 and fans 304, 308 accordingly. Thermal module 228 may provide heating or cooling to possibly maintain visibility through window 234 and/or to keep within the operating temperature range of the modular components of the camera system. In another embodiment, the fans are powered directly by power supply sub-module 225 to ensure good air circulation within the enclosure without being dependent upon the heater controller.

Interface 223 may include resistors 311, 313, 315, 317 which are zero ohm jumpers that, in combination, identify the version of housing module 224. For example, system controller 254 may read the levels of voltage present at an I/O device on the communications module 226 via 12C communications to thereby determine the version of housing module 224.

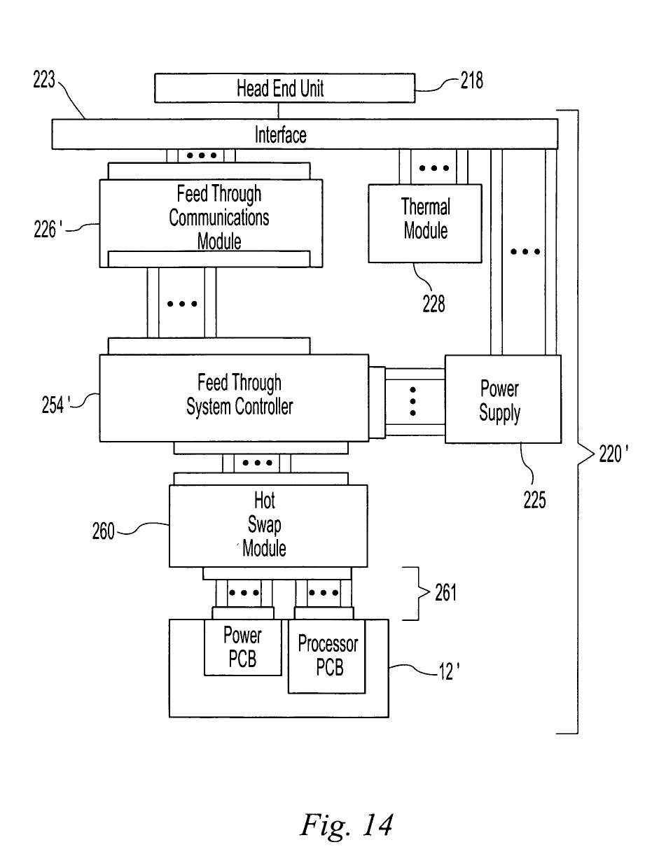

FIG. 14 illustrates a surveillance camera system 220′ that is formed of another combination of modules. That is, camera system 220′ includes modules of different versions as compared to the corresponding like modules shown in FIGS. 9-13. More particularly, camera system 220′ includes a fixed camera head module 12′ which is manually adjustable. When fixed camera head module 12′ is utilized, the camera system may include a feed through system controller 254′ and a feed through communications module 226′. System controller 254′ may be electrically connected to a hot swap control module 260 which is, in turn, connected to fixed camera head module 12′ via a fixed camera wiring harness 261. Feed through system controller 254′ essentially passes power from power supply sub-module 225 to fixed camera head module 12′. Feed through system controller 254′ and feed through communications module 226′ also essentially pass video signals generated by fixed camera head module 12′ to head end unit 218 and may provide no control or other computerized functions. It is also possible for a surveillance camera system to include communications module 226 and system controller 254 in conjunction with fixed camera head module 12′.

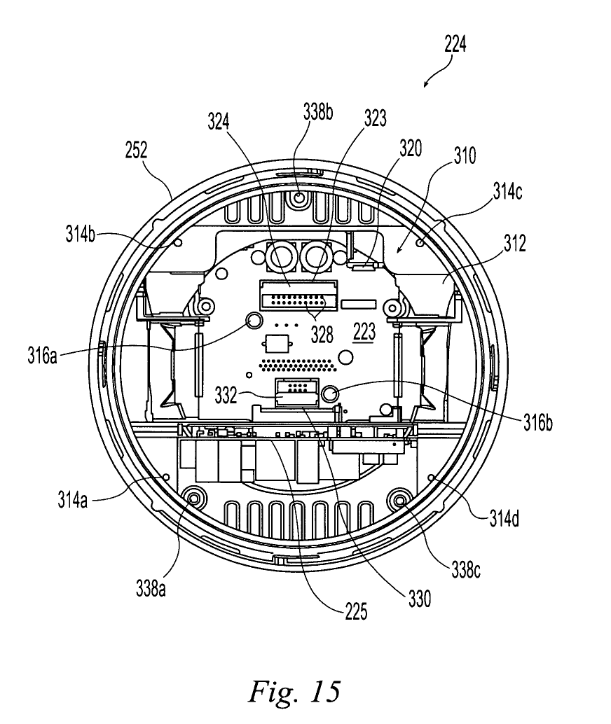

In one particular embodiment illustrated in FIGS. 15-23, interface board 223 and power supply sub-module 225 are included in a PCB support subassembly 310 that is mounted within housing 252 of camera housing module 224. PCB support subassembly 310 includes a body 312 that functions as an internal “chassis” to support interface board 223 and power supply sub-module 225 such that board 223 and sub-module 225 are fixedly assembled to each other and to housing 252. Body 312 may be attached to housing 252 at points 314a-d. Interface board 223 may be attached to housing 252 at points 316a-b to thereby providing electrical grounding.

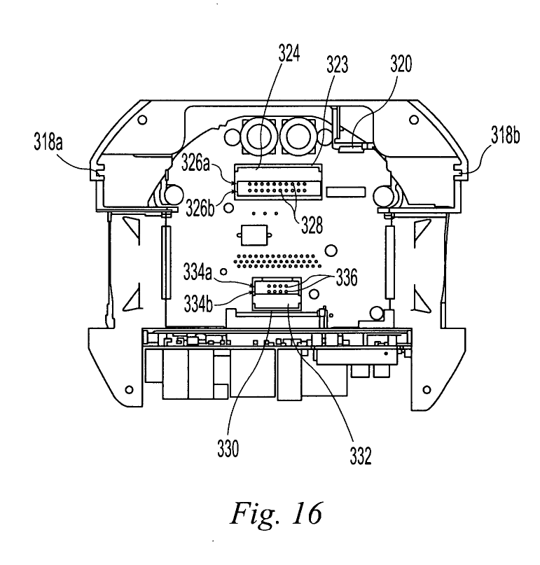

PCB support subassembly 310 may provide mechanical guidance and support for communications module 226 and thermal module 228 as modules 226, 228 are plugged into interface board 223. Body 312 may include guide slots 318a-b (FIG. 16) for receiving respective opposite edges of a circuit board of communications module 226. Body 312 may also include a mechanical snap retainer 320 for receiving communications module 226 in a snap fit engagement. Interface board 223 may include an electrical connector 323 for mating with a electrical connector on communications module 226. Connector 323 may be a type of connector referred to as a “header”. Connector 323 includes a slot 324 aligned with guide slots 318a-b such that slot 324 also receives a circuit board of communications module 226. Connector 323 also includes two rows 326a-b of pins 328 to be received in recesses of the receptacle-type electrical connector on communications module 226.

Interface board 223 may include another header-type electrical connector 330 for mating with a receptacle-type electrical connector on thermal module 228. Connector 330 includes a slot 332 that receives a circuit board of thermal module 228. Connector 330 also includes two rows 334a-b of pins 336 to be received in recesses of the receptacle-type electrical connector on thermal module 228.

PCB support subassembly 310 positions communications module 226 and thermal module 228 relative to housing 252 such that system controller 254 may electrically plug into modules 226, 228 when system control module 230 is mechanically coupled to housing 252, thereby retaining communications module 226 and the electrical portion of thermal module 228 within housing 252. As best shown in FIG. 15, housing 252 includes internally threaded screw bosses 338a-c for receiving screws 256.

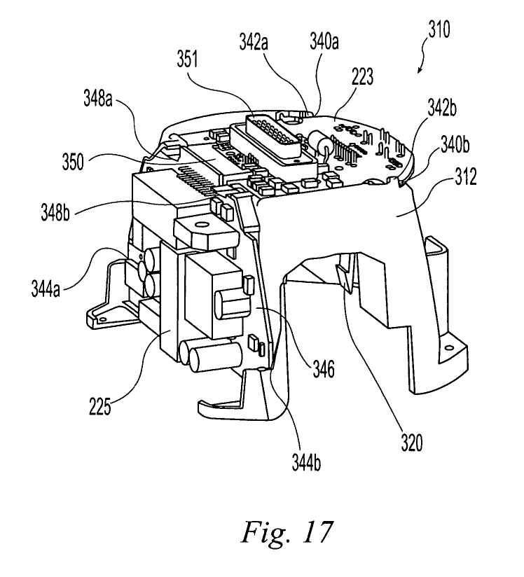

As shown in FIG. 17, body 312 may include opposing, parallel, horizontally-oriented grooves 340a-b for receiving opposite edges of interface board 223 therein. Body 312 may also include opposing mechanical snap retainers 342a-b for retaining interface board 223 in a snap fit engagement. Body 312 may include opposing, parallel, vertically-oriented grooves 344a-b for receiving opposite edges of a printed circuit board 346 of power supply sub-module 225 therein. Body 312 may also include mechanical snap retainers 348a-b for retaining power supply PC board 346 in a snap fit engagement. An electrical connector 350 may be used to connect interface board 223 and power supply PC board 346 together at a 90° angle to each other. Another electrical connector 351 may connect interface board 223 to connector 236 (FIG. 9) of mounting module 222.

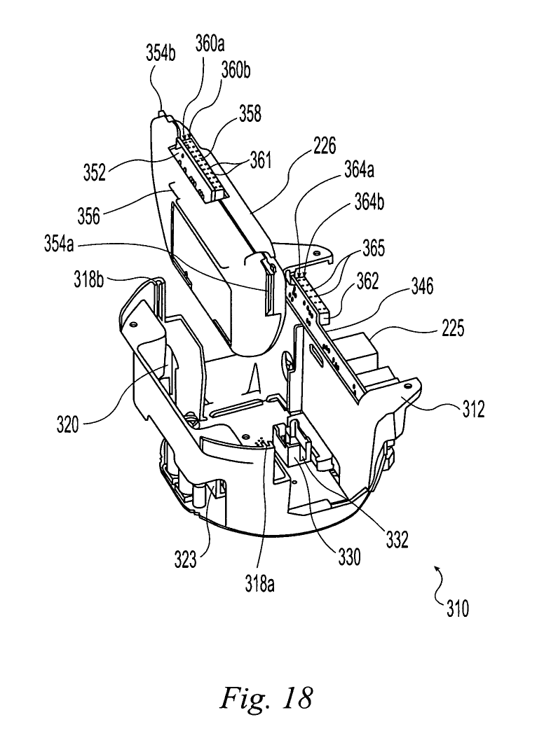

Communications module 226 may include a printed circuit board 352 (FIG. 18) having opposite protruding edges 354a-b received in respective slots 318a-b of body 312. Communications module 226 may also include a mechanical snap catch 356 for being latched onto by retainer 320 of body 312. Communications module 226 may further include a receptacle-type electrical connector 358 having rows 360a-b of recesses 361 for receiving the pins of a header-type connector on an upper surface 258 of system controller 254. Also shown in FIG. 18 is another receptacle-type electrical connector 362 attached to power supply sub-module 225. Connector 362 has rows 364a-b of recesses 365 for receiving the pins of another header-type connector on an upper surface of system controller 254.

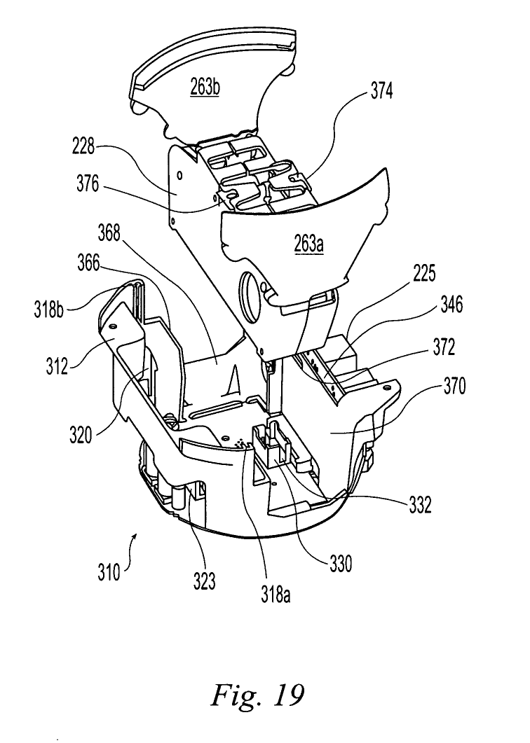

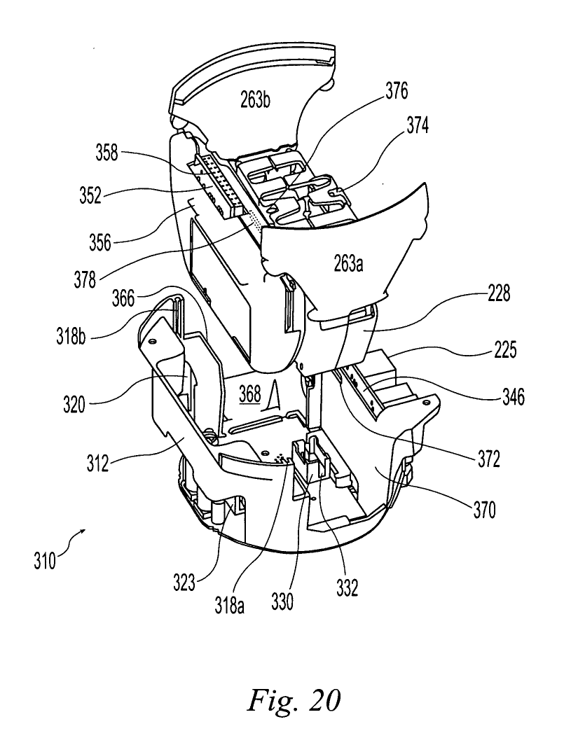

As shown in FIG. 19, body 312 may include guide walls 366, 368, 370 for mechanically guiding the insertion of thermal module 228 into PCB support subassembly 310 such that a receptacle-type connector on thermal module 228 is matingly engaged with header-type connector 330. Wall 370 may include a throughslot or recess 372 for receiving a snap retainer 374 of thermal module 228 such that thermal module 228 is attached to body 312 in a snap fit engagement. Thermal module 228 may include another snap retainer 376 that may be received in a recess 378 (FIG. 20) of communications module 226 such that thermal module 228 is also attached to communications module 226 in a snap fit engagement.

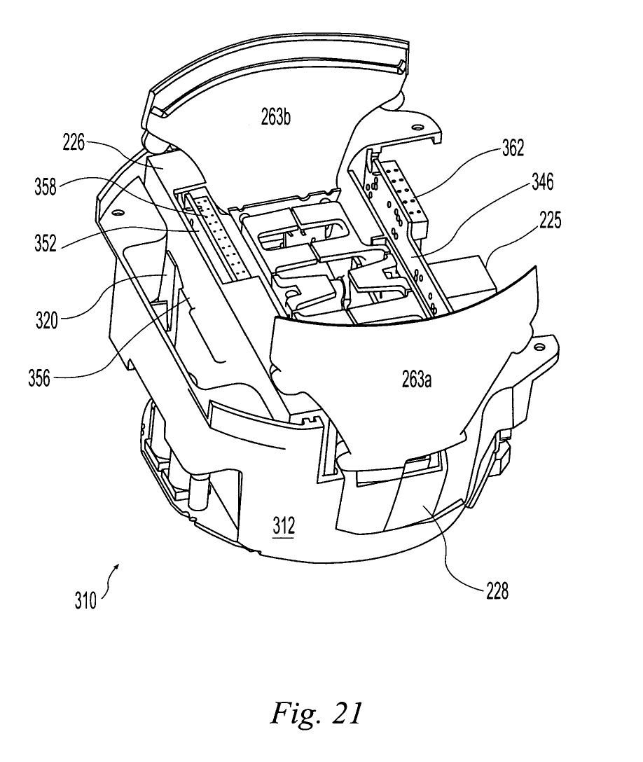

FIG. 21 illustrates communications module 226, thermal module 228 and PCB support subassembly 310 in a fully assembled state. Receptacle-type electrical connectors 358 and 362 of communications module 226 and power supply sub-module 225, respectively, are accessible in this fully assembled state to enable connection to the header-type connectors of system controller 254.

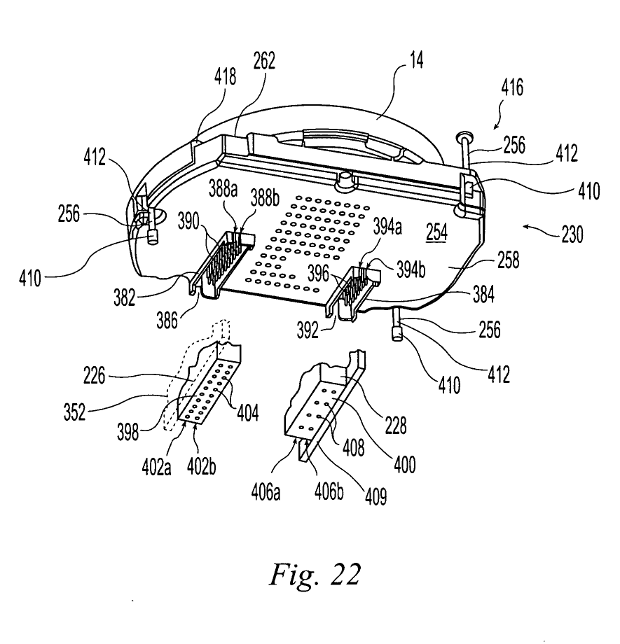

System controller 254 is shown in the overhead view of FIG. 22 as being nested in an upper surface of mounting frame 14. Upper surface 258 of controller 254 includes header-type connectors 382, 384 for matingly connecting with receptacle-type connectors 358 and 362, respectively, of communications module 226 and power supply sub-module 225, respectively. Connector 382 includes a slot 386 for receiving circuit board 352 of communications module 226. Connector 382 also includes two rows 388a-b of pins 390 to be received in recesses 361 of receptacle-type electrical connector 358 on communications module 226. Similarly, connector 384 includes a slot 392 for receiving circuit board 346 of power supply sub-module 225. Connector 384 also includes two rows 394a-b of pins 396 to be received in recesses 365 of receptacle-type electrical connector 362 on power supply sub-module 225.

Advantageously, exposed pins, i.e., pins 390, 396, are on the non-energized module, i.e., system controller module 230, rather than on the energized modules, i.e., communications module 226 and power supply sub-module 225. This configuration avoids accidental grounding or other electrical connection of an exposed, energized pin.

Also illustrated in FIG. 22 are receptacle-type connectors 398, 400 of communications module 226 and thermal module 228, respectively. Connector 398 includes rows 402a-b of recesses 404 for receiving pins 328 of header-type connector 323 of interface board 223. Similarly, connector 400 includes rows 406a-b of recesses 408 for receiving pins 336 of header-type connector 330 of interface board 223. A circuit board 409 of thermal module 228 may be received in slot 332. Header-type connectors that are suitable for use as connectors 323, 330, 382, 384, and receptacle-type connectors that are suitable for use as connectors 358, 362, 398, 400, are commercially available from AMP Inc. of Harrisburg, Pa.

Connector 398, circuit board 352 and snap catch 356 of communications module 226 conjunctively provide a quick-connector that enables communications module 226 to be connected to interface 223 by hand in a single unidirectional motion. As is evident from the drawings, the motion may be in an upward, vertical direction, such as from a ground surface towards a ceiling. Stated another way, the camera head, the system controller, the communications module and the interface board are generally aligned in an upward one of axial directions 70 (FIG. 2), and the motion may be in that upward axial direction. The quick-connector also enables communications module 226 to be disconnected from interface 223 by hand by deflecting snap retainer 320 laterally out of engagement with catch 356 and then pulling communications module 226 downward away from interface 223. Similarly, connector 358 and circuit board 352 provide another quick-connector that enables communications module 226 and system controller 254 to be connected by hand in a single unidirectional motion. The connection may be achieved by moving system controller 254 in an upward, vertical direction such that header-type connector 382 mates with connector 358 and circuit board 352. The quick-connector also enables communications module 226 and system controller 254 to be disconnected by hand by pulling system controller 254 downward away from communications module 226.

Thermal module 228 also includes a quick-connector for connecting to interface 223. Connector 400, circuit board 409, and snap retainers 374, 376 conjunctively provide a quick-connector that enables thermal module 228 to be connected to interface 223 and to communications module 226 by hand in a single unidirectional motion. Again, the motion may be in an upward, vertical direction, such as from a ground surface towards a ceiling. Stated another way, the camera head, the system controller, the thermal module and the interface board are generally aligned in an upward one of axial directions 70, and the motion may be in that upward axial direction. The quick-connector also enables thermal module 228 to be disconnected from interface 223 and communications module 226 by hand by deflecting snap retainers 374, 376 laterally out of engagement with respective recesses 372, 378 and then pulling thermal module 228 downward away from interface 223.

Alternatively, communications module 226 and thermal module 228 may be assembled together as shown in FIG. 20 and then inserted as a unit into PCB support subassembly 310. In this case, the respective quick connectors of communications module 226 and thermal module 228 may cooperatively function as a single quick connector that enables the subassembly including communications module 226 and thermal module 228 to be connected to interface 223 by hand in a single unidirectional motion.

Further illustrated in FIG. 22 are a threaded portion 410 and unthreaded portion 412 of each of screws 256. Threaded portion 410 may be wider than both unthreaded portion 412 and a screw hole 414 (FIG. 1) of mounting frame 14 through which unthreaded portion 412 extends. In order to secure system control module 230 to housing 252, each of screws 256 is screwed into a respective one of internally threaded screw bosses 338a-c of housing 252. Advantageously, if a threaded portion 410 is not threaded into a respective screw boss 338 during assembly, then screw 256 will drop until threaded portion 410 engages mounting frame 14, as indicated at arrow 416 in FIG. 22. Thus, the elongate unthreaded portion 412 will hang below mounting frame 14, making it very evident to the installer that screw 256 is not screwed into its corresponding screw boss 338.

A modular surveillance camera kit of the present invention may include a group of system controllers of various versions, such as basic, standard, high-end, or pass-through. A pass through system controller is illustrated in FIG. 14 in conjunction with a fixed camera head. The shields or outer casing of the system control module may be electrically conductive. When the system controller is attached to an electrically conductive housing, screws 256 may function as grounding screws. Thus, the system control module may provide an effective electro-magnetic interference shield for the communications module, the thermal module, the power supply sub-module, and the interface board. The position of the system control module relative to the non-conductive enclosure window may maximize the EMI shielding of the system. The system control module may include memory to store all camera pre-positions and other location-specific settings. Thus, if a camera head is replaced, extensive re-setup by the user is not required.

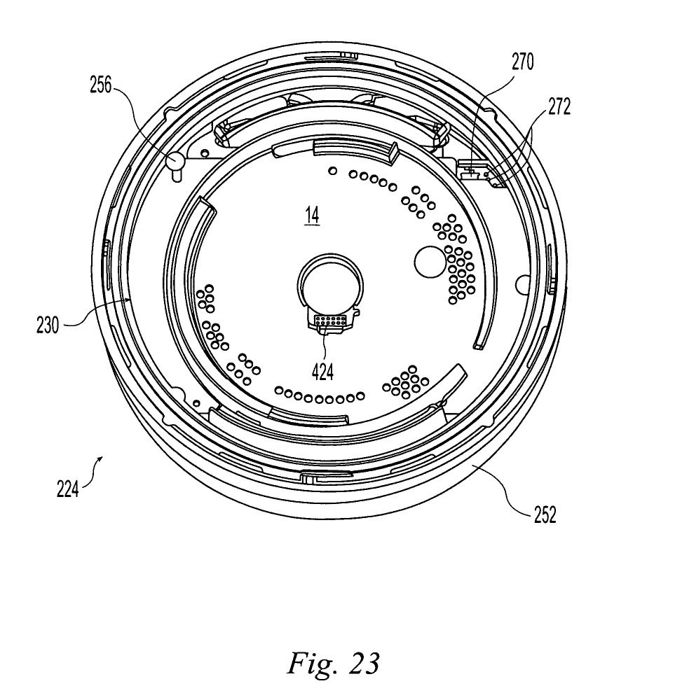

Mounting frame 14 includes a cutout or notch 418 that enables a serviceman to view light emitting diodes 272 (FIG. 23) and switch 270 on a corner of a lower surface 262 of system controller 254. LEDs 272 and switch 270 may be used by the serviceman for diagnostic purposes, for example. System controller 254 may include a receptacle-type connector 424 for mating with twelve-pin connector 48 (FIG. 4).

During service or assembly, a user or repair person of camera system 220 may advantageously remove and replace each of the modules of camera system 220 with an upgraded version or with a repaired version of each module. Camera system 220 has modular capability, i.e., each component may be replaced or repaired without removing or reinstalling the entire camera system 220. For example, communications module 226 may be removed and replaced with an upgraded module or with a repaired module, if module 226 has malfunctioned, without changing the components or the configuration of the remainder of camera system 220. As described above, the user may selectively remove module 226 from its mechanical and electrical connections to system control module 230 and to interface board 223. Similarly, thermal management module 228, camera head 12, and system control module 230 may be selectively removed and replaced with an upgraded but like module or with a repaired like module without changing the components or the configuration of the remainder of camera system 220.

Due to the modularity of the camera system, the present invention may be provided in the form of a kit including groups of different versions of the various modules. The versions of the modules may differ in terms of their respective set of performance characteristics, but may have the same shape, size, and mechanical and electrical connectors. The installer may assemble a surveillance camera system in a selected one of a plurality of possible combinations by selecting one version from each module group.

Due to the common size and shape of the modules within a certain group, any combination of the communications module and the thermal module may fit within the housing. Further, any camera head module may be coupled to the housing such that the camera head is disposed at least partially outside of the housing.

Advantageously, system controller 254 may be provided with the ability to intelligently record and monitor error events and installation of new and different components into camera system 220. System controller 254 may profile camera system 220 to provide diagnostic capabilities to camera system 220. The profiling of camera system 220 may include polling each component, e.g., camera head 12, communications module 226, thermal management module 228, interface 223, and power supply sub-module 225, to determine a modular configuration. Each module in camera system 220 includes identification features which allow system controller 254 to determine what type or version of each module is present in the system after the system has been assembled. For example, camera head module 12 or any other module may include an electronically readable identification number which is unique to each module. The software in system controller 254 may read this number and modify the operation of camera system 220 depending on which type or version of camera head module 12 or other module is installed. System controller 254 may use analog or digital communication means between respective modules of camera system 220 to obtain the relevant diagnostic information. If a system controller is reassembled in an other surveillance camera system, then the system controller may again ascertain the identification of the various module of the system, and again operate the system based upon the identifications.

System controller 254 may include software that monitors and logs when errors occur in camera system 220. For example, if camera head module 12, or any other module of camera system 220, is malfunctioning, e.g., has lost the video signal, system controller 254 can log this information and store it for later retrieval by a service technician. Alternatively, system controller 254 can log the information and simultaneously report the error to a remote source, such as to head end unit 218 or to a central communication hub of a residence or business. The logged error information may be remotely retrieved by any well-known method. System controller 254 also may have the capability to alert a user or technician when an invalid or incompatible configuration of the camera system has been assembled.

System controller 254 may also include software that is capable of monitoring and recognizing when a new or different module has been installed in camera system 220. For example, if camera head module 12 is removed and replaced with a new or different version of camera head module, then system controller 254 may poll the new camera head module via the electrical connections therebetween to determine what type of camera head module is present in the camera system and to ensure that a video signal is being detected. The system controller may then re-initialize or re-profile the entire camera system and may control or operate the entire camera system, or at least portions of the camera system, depending upon the new system configuration. For example, the drive current to the PTZ motors may be set based on the particular modules included in the system, or on low temperature events that have been sensed.

System controller 254 may also include software that is capable of identifying whether a thermal management module is installed and whether power is connected to the installed thermal management module. System controller 254 may monitor the temperature of camera system 220 via signals from thermal management module 228 and warn a user or technician that a more powerful heater may be needed, or that the camera system is operating in an environment that exceeds recommended environmental operating ranges or ratings of the individual modules. System controller 254 may further include software that can detect what type of housing and surveillance window are present in the camera system. For example, system controller 254 may determine whether the housing is an indoor, outdoor, pendant, and/or pressurized housing.

As mentioned above, interface 223 may include resistors 311, 313, 315, 317 (FIG. 13) which, in combination, identify the version of housing module 224. For example, system controller 254 may read the values of resistors 311, 313, 315, 317 through communications module 226 to thereby determine the version of housing module 224.

As also mentioned above, resistors 292, 294 (FIG. 13) form a voltage divider that produces a voltage level at node 296 that may be used by system controller 254 to identify the version of communications module 226 by reference to fixed values in a table. That is, the values of resistors 292, 294 may uniquely identify the version of communications module 226, e.g., whether the communications module has communications ability, is Ethernet compatible, is intelligent and operates according to a specific protocol, which could be a protocol developed by another competing company. If the communications module is intelligent, then the system controller may poll the communications module for its type or version using the communications module's reception (Rx) and transmission (Tx) lines. The resistance of one of resistors 292, 294 may be fixed for each version of the communications module, and the resistance of the other resistor may be set at the factory, such as via a potentiometer, according to the version of the communications module. The voltage level may be read by using an analog-to-digital converter integral to the microprocessor on the system controller. If the type is an intelligent device, then SCI port 2 on the system controller may be used to communicate with the communications module to determine its type.

In order to identify the version of the thermal module, two isolated outputs 428, 430 (FIG. 13) of the thermal module may be read by the system controller via the I2C digital I/O device 282 on the power supply sub-module. Auxiliary outputs 428, 430 may also indicate whether power is being provided to the heater block portion of the thermal module as part of diagnostics.

General purpose input/output pins on the microprocessor on the system controller itself may be read by the microprocessor to identify standard, basic or video content analysis (VCA) system controller hardware versions so that the software knows what portions to run or what software portions to defeature. For example, in the case of a VCA system controller, there may be a different bit file for FPGA 249 (FIG. 12) and an HPI16 interface to initialize as well as additional processor interrupts.

The system controller may read and store the housing type, heater module type, camera module type and communications module type for diagnostic purposes. The camera module and intelligent communications modules may be polled via serial communications allowing for an infinite number of types, i.e., versions. All camera modules may have serial communications capability for diagnostics and data setup purposes. Each camera head module may have an electronically readable unique identification number that may be used to determine when a camera head module is replaced with a like kind module. For example, the system controller may use an SCI port 3 on a microprocessor to communicate with the camera module to poll it for camera identification information. In addition, a fixed or PTZ head can be determined by the digital level on the tilt home signal coming through the slip ring by trying to move off of the home level. This can also be used for diagnostic purposes because only certain camera types may go on PTZ heads.

Generally, the system controller may generate an output signal including an identification of the system controller, an identification of the selected camera head, an identification of the selected communications module, an identification of the housing module, and diagnostic information associated with the system controller, the selected camera head, the selected housing module and/or the selected communications module. The module identifications may each correspond to a respective set of performance characteristics. The system controller may determine, based upon the module identifications, whether the selected modules are operationally compatible with one another, and notify the user if incompatibility is determined.

The system control module may, in addition to ascertaining identifications of the various modules, collect diagnostic data and environmental data, such as temperature or humidity data, associated with operation of the various modules. The system controller may determine, based upon the identifications and the diagnostic data and/or environmental data whether any of the modules should be replaced with a like module having the same or different performance characteristics. The system controller may then notify the user if it is determined that a module should be replaced.

Readings from the thermal module may enable high temperature events to be logged in association with the particular modular configuration of the camera system. This enables the system to alert the user than the fans may not be operating, or that the system is operating in an environment that exceeds recommendations. Moreover, temperature profiles based on the particular modular configuration of the camera system may be monitored. Logging of such information may be useful when monitoring warranty returns. Further, certain error events, and the current modular configuration of the camera system, may be automatically reported to the user via an on-screen display in head end unit 218, or may be retrievable from an error log. For example, a system controller may report video loss to a central system. If such a report is received, then the operator knows that the error is somewhere in the camera head module, and may quickly change the camera head module in order to restore operation.

The present invention may enable remote identification of the particular modular configuration of the camera system, such as by head end unit 218. For example, head end unit 218 may determine via the system controller whether the housing module includes an indoor or outdoor housing, and whether the housing is pressurized.

While this invention has been described as having an exemplary design, the present invention may be further modified within the spirit and scope of this disclosure. This application is therefore intended to cover any variations, uses, or adaptations of the invention using its general principles.

What is claimed is:

1. A modular surveillance camera kit, comprising:
a group of camera heads each having a respective set of performance characteristics;
a group of system controllers each having a respective set of performance characteristics; and
a group of communications modules each having a respective set of performance characteristics, each of said communications modules being configured to be coupled to a system interface;
wherein a surveillance camera system may be assembled in a selected one of a plurality of possible combinations by selecting one of said group of camera heads, one of said group of system controllers and one of said group of communications modules such that said selected system controller electrically and mechanically interconnects said selected camera head and said selected communications module, each said system controller being configured to:
ascertain an identification of at least one of said selected camera head and said selected communications module that is assembled in a same said surveillance camera system as said system controller; and
operate said surveillance camera system dependent upon the identification.

2. The modular surveillance camera kit of claim 1, wherein each said system controller is configured to ascertain the identification after said surveillance camera system has been assembled.

3. The modular surveillance camera kit of claim 1, further comprising a group of thermal modules, each of said thermal modules being configured to be coupled to the system interface, wherein said assembled surveillance camera system includes a selected one of said group of thermal modules, each said system controller being configured to:
ascertain an identification of said selected thermal module that is assembled in a same said surveillance camera system as said system controller; and
operate said surveillance camera system dependent upon the thermal module identification.

4. The modular surveillance camera kit of claim 1, wherein the identification of at least one of said selected camera head and said selected communications module corresponds to said respective set of performance characteristics.

5. The modular surveillance camera kit of claim 1, wherein each said system controller is configured to again ascertain the identification and again operate dependent upon the identification when said system controller is reassembled in an other surveillance camera system.

6. The modular surveillance camera kit of claim 1, wherein each said system controller is configured to generate an output signal including:
an identification of said system controller;
an identification of said selected camera head;
an identification of said selected communications module; and
diagnostic information associated with at least one of said system controller, said selected camera head, and said selected communications module.

7. The modular surveillance camera kit of claim 1, further comprising a group of housings each including a respective version of the system interface, wherein said assembled surveillance camera system includes a selected one of said group of housings, each said system controller being configured to:
ascertain an identification of said selected housing that is assembled in a same said surveillance camera system as said system controller; and
operate said surveillance camera system dependent upon the housing identification.

8. A modular surveillance camera kit, comprising:
a group of camera heads each having a respective set of performance characteristics;
a group of system controllers each having a respective set of performance characteristics; and
a group of communications modules each having a respective set of performance characteristics, each of said communications modules being configured to be coupled to a system interface;
wherein a surveillance camera system may be assembled in a selected one of a plurality of possible combinations by selecting one of said group of camera heads, one of said group of system controllers and one of said group of communications modules such that said selected system controller electrically and mechanically interconnects said selected camera head and said selected communications module, each said system controller being configured to:
ascertain identifications of said selected camera head and of said selected communications module that are assembled in a same said surveillance camera system as said system controller;
determine, based upon the identifications, whether said selected camera head, said selected communications module and said system controller that are assembled in said same surveillance camera system are operationally compatible with one another; and
notify a user if said selected camera head, said selected communications module and said system controller that are assembled in said same surveillance camera system are not operationally compatible with one another.

9. The modular surveillance camera kit of claim 8, wherein each said system controller is configured to ascertain the identifications after said surveillance camera system has been assembled.

10. The modular surveillance camera kit of claim 8, further comprising a group of thermal modules, each of said thermal modules being configured to be coupled to the system interface, wherein said assembled surveillance camera system includes a selected one of said group of thermal modules, each said system controller being configured to:
ascertain an identification of said selected thermal module that is assembled in a same said surveillance camera system as said system controller;
determine, based upon the identifications, whether said selected camera head, said selected communications module, said selected thermal module and said system controller that are assembled in said same surveillance camera system are operationally compatible with one another; and
notify a user if said selected camera head, said selected communications module, said selected thermal module and said system controller that are assembled in said same surveillance camera system are not operationally compatible with one another.

11. The modular surveillance camera kit of claim 8, wherein the identifications of said selected camera head and of said selected communications module each correspond to a respective said set of performance characteristics.

12. The modular surveillance camera kit of claim 8, wherein each said system controller is configured to again ascertain the identifications, again determine operational compatibility, and again notify a user if incompatibility is determined, when said system controller is reassembled in an other surveillance camera system.

13. The modular surveillance camera kit of claim 8, further comprising a group of housings each including a respective version of the system interface, wherein said assembled surveillance camera system includes a selected one of said group of housings, each said system controller being configured to:
ascertain an identification of said selected housing that is assembled in said same surveillance camera system as said system controller;
determine, based upon the identifications, whether said selected camera head, said selected communications module, said selected housing and said system controller that are assembled in said same surveillance camera system are operationally compatible with one another; and
notify a user if said selected camera head, said selected communications module, said selected housing and said system controller that are assembled in said same surveillance camera system are not operationally compatible with one another.

14. A surveillance camera system, comprising:
a camera head module;
a communications module configured to be coupled to a system interface;
a thermal module; and
a system controller module in communication with each of said camera head module, said communications module, and said thermal module, said system controller being configured to:
ascertain identifications of said camera head module, of said communications module, and of said thermal module, each of said identifications corresponding to a respective set of performance characteristics;
collect at least one of diagnostic data and environmental data associated with operation of at least one of said camera head module, said communications module, said thermal module, and said system controller module;
determine whether at least one of said camera head module, said communications module, said thermal module, and said system controller module should be replaced with a like module, said determination being based upon the identifications and upon said at least one of diagnostic data and environmental data; and
notify a user if at least one of said camera head module, said communications module, said thermal module, and said system controller module should be replaced.

15. The surveillance camera system of claim 14, wherein said system controller module is configured to ascertain the identifications after said surveillance camera system has been assembled.

16. The surveillance camera system of claim 14, wherein said system controller module is configured to:
determine whether at least one of said camera head module, said communications module, said thermal module, and said system controller module should be replaced with a like module having a different set of performance characteristics, said determination being based upon said identifications and upon said at least one of diagnostic data and environmental data; and
notify a user if at least one of said camera head module, said communications module, said thermal module, and said system controller module should be replaced with a like module having a different set of performance characteristics.

17. The surveillance camera system of claim 14, wherein said system controller module is configured to operate said camera head based upon said at least one of diagnostic data and environmental data.

18. The surveillance camera system of claim 14, wherein said at least one of diagnostic data and environmental data comprises temperature data.

19. A modular surveillance camera kit, comprising:
a group of camera heads each having a respective set of performance characteristics;
a group of system controllers each having a respective set of performance characteristics;
a group of communications modules each having a respective set of performance characteristics, each of said communications modules being configured to be coupled to a system interface; and
a group of thermal modules each having a respective set of performance characteristics;
wherein a surveillance camera system may be assembled in a selected one of a plurality of possible combinations by selecting one of said group of camera heads, one of said group of system controllers, one of said group of communications modules and one of said group of thermal modules such that said selected system controller electrically and mechanically interconnects said selected camera head and said selected communications module, and said selected thermal module is in communication with said system controller, each said system controller being configured to:
ascertain identifications of said selected camera head, of said selected communications module, and of said selected thermal module that are assembled in a same said surveillance camera system as said system controller;
collect at least one of diagnostic data and environmental data associated with operation of said assembled surveillance camera system;
determine whether at least one of said selected camera head, said selected communications module, said selected thermal module, and said system controller that are assembled in said same surveillance camera system should be replaced with an other of a same said group, said determination being based upon the identifications and upon said at least one of diagnostic data and environmental data; and
notify a user if at least one of said selected camera head, said selected communications module, said selected thermal module, and said system controller that are assembled in said same surveillance camera system should be replaced.

20. The modular surveillance camera kit of claim 19, wherein each said system controller is configured to ascertain the identifications after said surveillance camera system has been assembled.

21. The surveillance camera kit of claim 19, wherein said system controller module is configured to operate said camera head based upon said at least one of diagnostic data and environmental data.

22. The modular surveillance camera kit of claim 19, wherein the identifications of said selected camera head, of said selected communications module, and of said selected thermal module each correspond to a respective said set of performance characteristics.

23. The modular surveillance camera kit of claim 19, wherein said at least one of diagnostic data and environmental data comprises temperature data.
